(19) United States
(12) Patent Application Publication
(10) Pub. No.: US 2022/0156641 A1
(43) Pub. Date: May 19, 2022

(54) SCORE DISTRIBUTION TRANSFORMATION DEVICE, SCORE DISTRIBUTION TRANSFORMATION METHOD, AND SCORE DISTRIBUTION TRANSFORMATION PROGRAM

(71) Applicant: NEC Corporation, Minato-ku, Tokyo (JP)

(72) Inventor: Toshihiko FUJII, Tokyo (JP)

(73) Assignee: NEC Corporation, Minato-ku, Tokyo (JP)

(21) Appl. No.: 17/437,486

(22) PCT Filed: Mar. 12, 2020
(86) PCT No.: PCT/JP2020/010893

§ 371 Date: Sep. 9, 2021

(30) Foreign Application Priority Data
Mar. 19, 2019 (JP) 2019-051121

(51) Int. Cl. G06N 20/00; G06Q 40/04; G06K 9/62

(52) U.S. Cl. CPC G06N 20/00; G06K 9/6247; G06K 9/6277; G06Q 40/04

(57) ABSTRACT

A first distribution calculation unit 81 calculates a first distribution, which is a distribution of scores obtained by applying each data included in a first group of data to a first model. A second distribution calculation unit 82 calculates a second distribution, which is a distribution of scores obtained by applying each data included in a second group of data to a second model. A transformation unit 83 transforms the second distribution so as to approximate the first distribution. The first group of data and the second group of data are data from the same domain, and a range of scores obtained by applying the data to the first model and a range of scores obtained by applying the data to the second model are identical.

### TECHNICAL FIELD

The present invention relates to a score distribution transformation device, a score distribution transformation method, and a score distribution transformation program that transform the distribution of scores output by a plurality of models.

### BACKGROUND ART

When trying to identify data with specific characteristics from a huge amount of data, the data is roughly selected based on the score that indicates the characteristic of the data from the viewpoint of efficiently extracting the target. By setting a threshold for the calculated score in advance, the user can determine that data outside the set threshold is unnecessary to check.

For example, PTL 1 discloses a scoring system for calculating a score that reflects the probability of fraudulent use of a credit card. The system disclosed in PTL 1 adds items included in the history data of each user to the items that are subject to score accumulation, and calculates a score reflecting the probability of fraudulent use based on the probability of fraudulent appearance based on the unique items.

### CITATION LIST

### Patent Literature

PTL 1: Japanese Unexamined Patent Application Publication No. 2007-207011

### SUMMARY OF INVENTION

### Technical Problem

In recent years, models for predicting scores that indicate feature-like characteristics learned by machine learning, including Heterogeneous Mixture Modeling, are sometimes used to calculate scores. It is known that retraining such models with new training data can change the accuracy of the scores calculated by the models. For example, by training the model with increased training data, it is possible to replace the model with a more accurate model.

On the other hand, if the accuracy with which scores are calculated changes, and the trend in the distribution of scores calculated for data changes, the user trying to extract data has the problem of having to re-determine the threshold of the score to be checked.

For example, suppose that in the old model, the data to be inspected was selected with a threshold value of 0.4. Now, suppose that the accuracy is improved by updating to the new model, and since the threshold value of 0.4 selects a large amount of data, the threshold value must be set to 0.2 in order to select the same amount of data. In this case, the user has to adjust the threshold according to the distribution of scores (the accuracy of the model) generated each time the model is updated.

The score calculated by the system disclosed in PTL 1 may also change each time it is calculated, depending on the items contained in the historical data of each user.

It is burdensome for the user to adjust the threshold every time the calculation is done again or the model is updated. In addition, it is desirable that the threshold value used for the decision to perform sorting does not change before and after the model is changed. Therefore, in order to use the same threshold value, it is desirable that the absolute value of the score can be interpreted as equivalent to that of the model before the change, even if the model is changed.

Therefore, it is an object of the present invention to provide a score distribution transformation device, a score distribution transformation method, and a score distribution transformation program that can transform the distribution of scores so that the interpretation of scores for the same data can be maintained before and after the model for calculating scores is changed.

### Solution to Problem

A score distribution transformation device according to the present invention includes: a first distribution calculation unit that calculates a first distribution, which is a distribution of scores obtained by applying each data included in a first group of data to a first model; a second distribution calculation unit that calculates a second distribution, which is a distribution of scores obtained by applying each data included in a second group of data to a second model; and a transformation unit that transforms the second distribution so as to approximate the first distribution, wherein the first group of data and the second group of data are data from the same domain, and a range of scores obtained by applying the data to the first model and a range of scores obtained by applying the data to the second model are identical.

Another score distribution transformation device according to the present invention includes: a first distribution calculation unit that calculates a first distribution which is a distribution of scores indicating a likelihood of an illegal transaction obtained by applying each stock transaction data included in a first group of data to a first model which is a model for estimating whether a transaction is illegal or not; a second distribution calculation unit that calculates a second distribution which is a distribution of scores indicating a likelihood of an illegal transaction obtained by applying each stock transaction data included in a second group of data to a second model which is a model for estimating whether a transaction is illegal or not generated after the first model; and a transformation unit that transforms the second distribution so as to approximate the first distribution.

A score distribution transformation method according to the present invention includes: calculating a first distribution, which is a distribution of scores obtained by applying each data included in a first group of data to a first model; calculating a second distribution, which is a distribution of scores obtained by applying each data included in a second group of data to a second model; and transforming the second distribution so as to approximate the first distribution, wherein the first group of data and the second group of data are data from the same domain, and a range of scores obtained by applying the data to the first model and a range of scores obtained by applying the data to the second model are identical.

Another score distribution transformation method according to the present invention includes: calculating a first distribution which is a distribution of scores indicating a likelihood of an illegal transaction obtained by applying each stock transaction data included in a first group of data to a first model which is a model for estimating whether a transaction is illegal or not; calculating a second distribution which is a distribution of scores indicating a likelihood of an illegal transaction obtained by applying each stock transaction data included in a second group of data to a second model which is a model for estimating whether a transaction is illegal or not generated after the first model; and transforming the second distribution so as to approximate the first distribution.

A score distribution transformation program according to the present invention causes a computer to execute: first distribution calculation processing of calculating a first distribution, which is a distribution of scores obtained by applying each data included in a first group of data to a first model; second distribution calculation processing of calculating a second distribution, which is a distribution of scores obtained by applying each data included in a second group of data to a second model; and transformation processing of transforming the second distribution so as to approximate the first distribution, wherein the first group of data and the second group of data are data from the same domain, and a range of scores obtained by applying the data to the first model and a range of scores obtained by applying the data to the second model are identical.

Another score distribution transformation program according to the present invention causes a computer to execute: first distribution calculation processing of calculating a first distribution which is a distribution of scores indicating a likelihood of an illegal transaction obtained by applying each stock transaction data included in a first group of data to a first model which is a model for estimating whether a transaction is illegal or not; second distribution calculation processing of calculating a second distribution which is a distribution of scores indicating a likelihood of an illegal transaction obtained by applying each stock transaction data included in a second group of data to a second model which is a model for estimating whether a transaction is illegal or not generated after the first model; and transformation processing of transforming the second distribution so as to approximate the first distribution.

### Advantageous Effects of Invention

According to this invention, it is possible to transform the distribution of scores so that the interpretation of scores for the same data can be maintained before and after the model for calculating scores is changed.

### BRIEF DESCRIPTION OF DRAWINGS

FIG. 1 It depicts a block diagram illustrating an exemplary embodiment of the score distribution transformation device according to the present invention.

FIG. 2 It depicts an explanatory diagram illustrating an example of a first distribution and a second distribution.

FIG. 3 It depicts an explanatory diagram illustrating an example of applying the inverse function of the sigmoid function to scores included in each graph.

FIG. 4 It depicts an explanatory diagram illustrating an example of a shape approximation transformation of a graph.

FIG. 5 It depicts an explanatory diagram illustrating an example of applying a sigmoid function.

FIG. 6 It depicts a flowchart illustrating an operation example of the score distribution transformation device.

FIG. 7 It depicts a block diagram illustrating an outline of the score distribution transformation device according to the present invention.

FIG. 8 It depicts a block diagram illustrating another outline of the score distribution transformation device according to the present invention.

FIG. 9 It is a schematic block diagram depicting a structure of a computer according to at least one exemplary embodiment.

### DESCRIPTION OF EMBODIMENTS

Hereinafter, an exemplary embodiment of the present invention will be described with reference to the drawings.

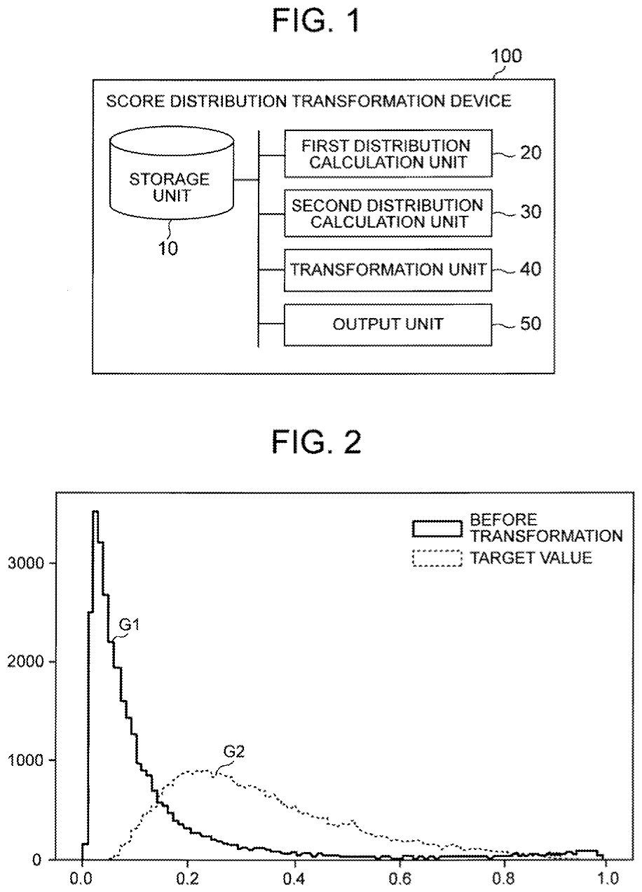

FIG. 1 is a block diagram illustrating an exemplary embodiment of a score distribution transformation device according to the present invention. The score distribution transformation device 100 according to the present exemplary embodiment includes a storage unit 10, a first distribution calculation unit 20, a second distribution calculation unit 30, a transformation unit 40, and an output unit 50.

The storage unit 10 stores a model for calculating a score and data to be applied to the model. This exemplary embodiment assumes a situation in which a model for estimating whether or not a transaction indicated by stock transaction data is an illegal transaction is used to calculate a score indicating a likelihood of an illegal of the transaction data. In other words, in this exemplary embodiment, the model is assumed in which a score indicating a likelihood of an illegal transaction is calculated by applying stock transaction data. However, the score to be calculated is not limited to the score indicating the likelihood of an illegal transaction.

In this exemplary embodiment, the score distribution transformation device 100 calculates the distribution of scores before and after updating the model. In the following description, the model before the update is written as an old model or a first model, and the model after the update is written as a new model or a second model. In other words, the second model is assumed to be the model generated after the first model. The storage unit 10 may store the models before and after the update in advance, or may store the generated model each time the model is updated.

The form of the model is arbitrary, for example, neural network or logistic regression. Both the new model and the old model are trained using data from the same domain. In this exemplary embodiment, the model is trained using stock trading data both before and after the update. In general, the new model is expected to have higher recognition accuracy than the old model because the new model has more data used for training than the old model. The storage unit 10 is realized by, for example, a magnetic disk.

The first distribution calculation unit 20 calculates the distribution of scores obtained by applying multiple data to the first model (hereinafter referred to as the first distribution). In the following description, the data group used to calculate the first distribution is referred to as a first group of data. In other words, the first distribution calculation unit 20 calculates the first distribution by applying each data included in the first group of data to the first model.

For example, when stock transaction data is used, the first distribution calculation unit 20 calculates the distribution of scores indicating a likelihood of an illegal transaction obtained by applying each stock transaction data included in the first group of data to the first model as the first distribution.

The second distribution calculation unit 30 calculates the distribution of scores obtained by applying multiple data to the second model (hereinafter referred to as the second distribution). In the following description, the data group used to calculate the second distribution is referred to as a second group of data. In other words, the second distribution calculation unit 30 calculates the second distribution by applying each data included in the second group of data to the second model. The second group of data may include data acquired after the data included in the first group of data, and may include at least some of the data included in the first group of data.

For example, when stock transaction data is used, the second distribution calculation unit 30 calculates the distribution of score indicating a likelihood of an illegal transaction obtained by applying each stock transaction data included in the second group of data to the second model generated after the first model as the second distribution. The first group of data and the second group of data are data from the same domain.

The transformation unit 40 transforms the second distribution so as to approximate the first distribution. Specifically, the transformation unit 40 transforms the second distribution so as to approximate the first distribution when the range of scores obtained by applying the data to the first model and the range of scores obtained by applying the data to the second model are the same. This corresponds, for example, to the fact that when the first model calculates the likelihood of an illegal transaction in the range of 0 to 1, the second model also calculates the likelihood of an illegal transaction in the range of 0 to 1.

First, the transformation unit 40 performs a logit transformation for each score included in the first and second distributions. Specifically, the transformation unit 40 applies the inverse function of the sigmoid function as a logit transformation to each score included in the first distribution and the second distribution. Hereafter, the first distribution and the second distribution after applying the inverse function of the sigmoid function are referred to as a first logit post-transformation distribution and a second logit post-transformation distribution, respectively.

Next, the transformation unit 40 performs a transformation to approximate the shape of the second logit post-transformation distribution to the first logit post-transformation distribution. Hereafter, the transformation to approximate the shape of the distribution is hereinafter referred to as a shape approximation transformation. Specifically, the transformation unit 40 performs the shape approximation transformation through the two processes described below.

First, as a first process, the transformation unit 40 approximates the width of the distribution by calculating the standard deviation of each score included in each logit post-transformation distribution. The transformation unit 40 may, for example, approximate the width of the distribution based on Equation 1 described below. Tmp in Equation 1 is the result of the temporary shape approximation transformation by the first process, and std is a function that calculates the standard deviation for the target score. Also, target in Equation 1 indicates the score included in the target distribution (i.e., the second distribution), and before indicates the score included in the distribution before the transformation (i.e., the first distribution).

tmp=before×(std(target)/std(before)) (Equation 1)

Next, as a second process, the transformation unit 40 performs a transformation to approximate the median value of each score included in the second logit post-transformation distribution to the median value of the first logit post-transformation distribution. The transformation unit 40 may, for example, approximate the median values based on Equation 2 described below. After in Equation 2 is the result of the final shape approximation transformation, and median is a function that calculates the median in the distribution.

after=tmp+(median(target)−median(tmp)) (Equation 2)

In addition to approximating the median of the first logit post-transformation distribution, the transformation unit 40 may also transform the distribution so that the standard deviation of the first logit post-transformation distribution is also approximated. The transformation unit 40 then applies a sigmoid function to each score included in the shape approximation transformed distribution. The transformation unit 40 can transform the second distribution to approximate the first distribution by performing the transformation described above.

The output unit 50 outputs the second distribution transformed by the transformation unit 40. In other words, the output unit 50 outputs the distribution that is the result of transforming the second distribution to approximate the first distribution.

The transformation process by the transformation unit 40 will be explained using specific examples below. FIG. 2 is an explanatory diagram illustrating an example of the first distribution and the second distribution. In FIG. 2, the “before transformation” graph G1, illustrated by the solid line, corresponds to the second distribution, and the “target value” graph G2, illustrated by the dotted line, corresponds to the first distribution. In other words, this specific example describes the process of transforming the “before transformation ” graph G1, which represents the second distribution, into the “target value” graph G2, which represents the first distribution.

In the example shown in FIG. 2, the horizontal axis shows the scores in the range of 0 to 1, which correspond to the scores indicating the likelihood of an illegal transaction, for example. The vertical axis shows the frequency of the score calculated by the model, which corresponds to the number of data indicating the corresponding likelihood of an illegal transaction, for example.

First, the transformation unit 40 applies the inverse function of the sigmoid function to the graph G1 and graph G2 illustrated in FIG. 2. FIG. 3 is an explanatory diagram illustrating an example of applying the inverse function of the sigmoid function to scores included in each graph illustrated in FIG. 2. Specifically, the result of applying the inverse function of the sigmoid function to graph G1 is graph G3, and the result of applying the inverse function of the sigmoid function to graph G2 is graph G4. By applying the inverse function of the sigmoid function to each graph, it is possible to transform each the graph into distributions with similar shapes, as illustrated in FIG. 3.

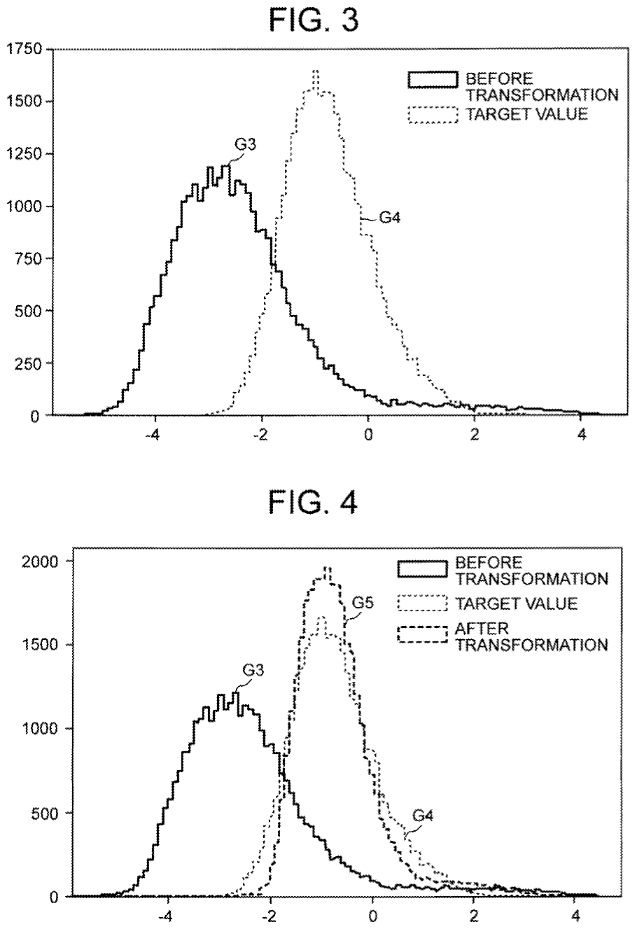

Next, the transformation unit 40 performs a transformation that approximates the shape of the graph G3 to the shape of the graph G4 illustrated in FIG. 3 (shape approximation conversion). Specifically, the transformation unit 40 transforms the shape of the graph G3 so as to approximate the width of the distribution to the shape of the graph G4 based on the Equation 1 shown above. Furthermore, the transformation unit 40 approximates the median of the transformed graph G3 to the median of the graph G4 based on the Equation 2 shown above. FIG. 4 is an explanatory diagram illustrating an example of a shape approximation transformation of the graph G3 illustrated in FIG. 3. By performing the shape approximation transformation, the transformation unit 40 generates a graph G5 that approximates the graph G3 to the graph G4.

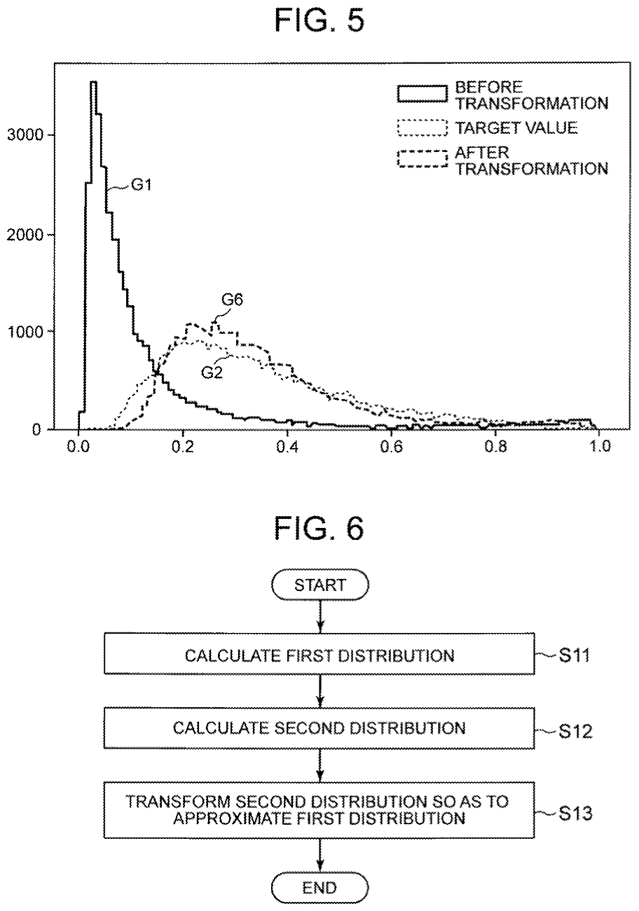

The transformation unit 40 then applies a sigmoid function to each score included in the graph G5 illustrated in FIG. 4. FIG. 5 is an explanatory diagram illustrating an example of applying a sigmoid function. As a result of applying the sigmoid function to each score included in the graph G5 illustrated in FIG. 4, a graph G6 is generated that approximates the graph G2, as illustrated in FIG. 5. The output unit 50 may output the graph G6.

For example, in the example shown in FIG. 5, it is possible to generate a distribution that approximates the first distribution by increasing the score from 0.1 before the transformation to about 0.3.

The first distribution calculation unit 20, the second distribution calculation unit 30, the transformation unit 40, and the output unit 50 are realized by a computer processor (for example, a central processing unit (CPU), a graphics processing unit (GPU)) that operates according to a program (score distribution transformation program).

For example, a program may be stored in the storage unit 10, and the processor may read the program and operate as the first distribution calculation unit 20, the second distribution calculation unit 30, the transformation unit 40, and the output unit 50 according to the program. The functions of the score distribution transformation device may be provided in a SaaS (Software as a Service) format.

The first distribution calculation unit 20, the second distribution calculation unit 30, the transformation unit 40, and the output unit 50 may each be realized by dedicated hardware. In addition, some or all of the components of each device may be realized by general purpose or dedicated circuits, a processor, or combinations thereof. These may be configured by a single chip or by multiple chips connected via a bus. Some or all of the components of each device may be realized by a combination of the above-mentioned circuits, etc. and programs.

Further, when some or all of the components of the score distribution transformation device are realized by multiple information processing devices, circuits, etc., the multiple information processing devices, circuits, etc. may be centrally located or distributed. For example, the information processing devices, circuits, etc. may be realized as a client server system, a cloud computing system, etc., each of which is connected via a communication network.

Next, a description will be given of an operation of the score distribution transformation device of the present exemplary embodiment. FIG. 6 is a flowchart illustrating an operation example of the score distribution transformation device 100 according to the present exemplary embodiment. The first distribution calculation unit 20 calculates the first distribution by applying each data included in the first group of data to the first model (step S11), and the second distribution calculation unit calculates the second distribution by applying each data included in the second group of data to the second model (step S12). Then, the transformation unit 40 transforms the second distribution so as to approximate the first distribution (Step S13).

As described above, in this exemplary embodiment, the first distribution calculation unit 20 calculates the first distribution by applying data to the first model, the second distribution calculation unit 30 calculates the second distribution by applying data to the second model, and the transformation unit 40 transforms the second distribution so as to approximate the first distribution. The first group of data and the second group of data are data from the same domain, and the range of scores obtained by applying the data to the first model and the range of scores obtained by applying the data to the second model are identical. Therefore, the distribution of scores can be transformed so that the interpretation of scores for the same data can be maintained before and after changing the model for calculating scores. This makes it possible to reduce the workload of users who sort data based on, for example, threshold values.

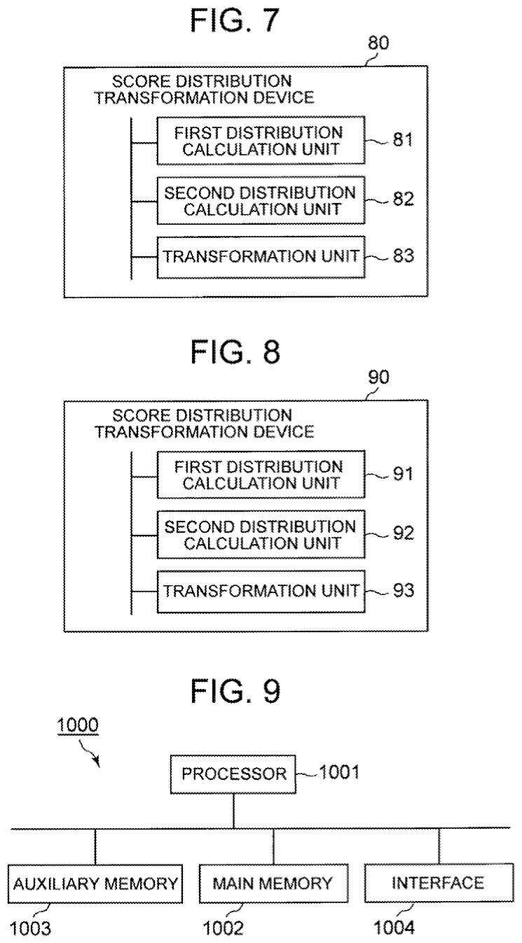

Next, an outline of the present invention will be described. FIG. 7 is a block diagram illustrating an outline of the score distribution transformation device according to the present invention. score distribution transformation device 80 (for example, a score distribution transformation device 100) according to the present invention includes a first distribution calculation unit 81 (for example, a first distribution calculation unit 20) that calculates a first distribution, which is a distribution of scores obtained by applying each data included in a first group of data to a first model, a second distribution calculation unit 82 (for example, the second distribution calculation unit 30) that calculates a second distribution, which is a distribution of scores obtained by applying each data included in a second group of data to a second model, and a transformation unit 83 (for example, the transformation unit 40) that transforms the second distribution so as to approximate the first distribution.

Here, the first group of data and the second group of data are data from the same domain, and a range of scores obtained by applying the data to the first model and a range of scores obtained by applying the data to the second model are identical (for example, the range of scores indicating a likelihood of an illegal transaction is 0 to 1).

Such a configuration allows the distribution of scores to be transformed so that the interpretation of scores for the same data can be maintained before and after the model for calculating scores is changed.

Specifically, the transformation unit 83 may perform a logit transformation on the first distribution and the second distribution, perform a shape approximation transformation (for example, a transformation based on Equation 1 and Equation 2 shown above) to approximate the shape of the logit transformed second distribution to the shape of the logit transformed first distribution, and perform a transformation to apply a sigmoid function to the shape approximation transformed distribution for the logit transformed second distribution to approximate the second distribution to the first distribution.

Here, the second model may be generated after the first model, and the second group of data includes at least some of the data included in the first group of data.

The score distribution transformation device 80 may also include an output unit (for example, output unit 50) that outputs the distribution that is the result of transforming the second distribution to approximate the first distribution.

For the score distribution transformation device 80 described above, the data included in the first group of data and the second group of data may be stock transaction data, and the first model and the second model may be models for estimating whether a transaction indicated by the stock transaction data is unauthorized transaction or not, and the second group of data may include data acquired after data included in the first group of data.

FIG. 8 is a block diagram illustrating another outline of the score distribution transformation device according to the present invention. The score distribution transformation apparatus 90 (for example, distribution transformation device 100) shown in FIG. 8 includes a first distribution calculation unit 91 (for example, first distribution calculation unit 20) that calculates a first distribution which is a distribution of scores indicating a likelihood of an illegal transaction obtained by applying each stock transaction data included in a first group of data to a first model which is a model for estimating whether a transaction is illegal or not, a second distribution calculation unit 92 (for example, the second distribution calculation unit 30) that calculates a second distribution which is a distribution of scores indicating a likelihood of an illegal transaction obtained by applying each stock transaction data included in a second group of data to a second model which is a model for estimating whether a transaction is illegal or not generated after the first model, and a transformation unit 93 (for example, transformation unit 40) that transforms the second distribution so as to approximate the first distribution.

Such a configuration also allows the distribution of scores to be transformed so that the interpretation of scores for the same data can be maintained before and after the model for calculating scores is changed. In particular, in the present exemplary embodiment, when sorting a predetermined amount of data in the distribution based on the setting of a score threshold, this configuration is particularly effective because it allows the user's experience of the score to be maintained before and after the model is changed.

FIG. 9 is a schematic block diagram depicting a structure of a computer according to at least one exemplary embodiment. A computer 1000 includes a processor 1001, a main storage device 1002, an auxiliary storage device 1003, and an interface 1004.

The score distribution transformation device described above is implemented by the computer 1000. The operation of each processing unit described above is stored in the auxiliary storage device 1003 in the form of a program (score distribution transformation program). The processor 1001 reads the program from the auxiliary storage device 1003, expands the program in the main storage device 1002, and executes the above-described process according to the program.

In at least one exemplary embodiment, the auxiliary storage device 1003 is an example of a non-transitory tangible medium. Examples of the non-transitory tangible medium include a magnetic disk, magneto-optical disk, CD-ROM (compact disc read-only memory), DVD-ROM (read-only memory), and semiconductor memory connected via the interface 1004. In the case where the program is distributed to the computer 1000 through a communication line, the computer 1000 to which the program has been distributed may expand the program in the main storage device 1002 and execute the above-described process.

The program may realize part of the above-described functions. The program may be a differential file (differential program) that realizes the above-described functions in combination with another program already stored in the auxiliary storage device 1003.

Some or all of the above exemplary embodiments may be described as in the following supplementary notes, but are not limited to the following.

(Supplementary note 1) A score distribution transformation device, comprising: a first distribution calculation unit that calculates a first distribution, which is a distribution of scores obtained by applying each data included in a first group of data to a first model; a second distribution calculation unit that calculates a second distribution, which is a distribution of scores obtained by applying each data included in a second group of data to a second model; and a transformation unit that transforms the second distribution so as to approximate the first distribution, wherein the first group of data and the second group of data are data from the same domain, and a range of scores obtained by applying the data to the first model and a range of scores obtained by applying the data to the second model are identical.

(Supplementary note 2) The score distribution transformation device according to Supplementary note 1, wherein the transformation unit performs a logit transformation on the first distribution and the second distribution, performs a shape approximation transformation to approximate the shape of the logit transformed second distribution to the shape of the logit transformed first distribution, and performs a transformation to apply a sigmoid function to the shape approximation transformed distribution for the logit transformed second distribution to approximate the second distribution to the first distribution.

(Supplementary note 3) The score distribution transformation device according to Supplementary note 1 or 2, wherein the second model is generated after the first model, and the second group of data includes at least some of the data included in the first group of data.

(Supplementary note 4) The score distribution transformation device according to any one of Supplementary notes 1 to 3, further comprising an output unit that outputs the distribution that is the result of transforming the second distribution to approximate the first distribution.

(Supplementary note 5) The score distribution transformation device according to any one of Supplementary notes 1 to 4, wherein the data included in the first group of data and the second group of data are stock transaction data, and the first model and the second model are models for estimating whether a transaction indicated by the stock transaction data is unauthorized transaction or not, and the second group of data includes data acquired after data included in the first group of data.

(Supplementary note 6) A score distribution transformation device, comprising: a first distribution calculation unit that calculates a first distribution which is a distribution of scores indicating a likelihood of an illegal transaction obtained by applying each stock transaction data included in a first group of data to a first model which is a model for estimating whether a transaction is illegal or not; a second distribution calculation unit that calculates a second distribution which is a distribution of scores indicating a likelihood of an illegal transaction obtained by applying each stock transaction data included in a second group of data to a second model which is a model for estimating whether a transaction is illegal or not generated after the first model; and a transformation unit that transforms the second distribution so as to approximate the first distribution.

(Supplementary note 7) A score distribution transformation method comprising: calculating a first distribution, which is a distribution of scores obtained by applying each data included in a first group of data to a first model; calculating a second distribution, which is a distribution of scores obtained by applying each data included in a second group of data to a second model; and transforming the second distribution so as to approximate the first distribution, wherein the first group of data and the second group of data are data from the same domain, and a range of scores obtained by applying the data to the first model and a range of scores obtained by applying the data to the second model are identical.

(Supplementary note 8) A score distribution transformation method according to Supplementary note 7, further comprising: performing a logit transformation on the first distribution and the second distribution; performing a shape approximation transformation to approximate the shape of the logit transformed second distribution to the shape of the logit transformed first distribution; and performing a transformation to apply a sigmoid function to the shape approximation transformed distribution for the logit transformed second distribution to approximate the second distribution to the first distribution.

(Supplementary note 9) A score distribution transformation method comprising: calculating a first distribution which is a distribution of scores indicating a likelihood of an illegal transaction obtained by applying each stock transaction data included in a first group of data to a first model which is a model for estimating whether a transaction is illegal or not; calculating a second distribution which is a distribution of scores indicating a likelihood of an illegal transaction obtained by applying each stock transaction data included in a second group of data to a second model which is a model for estimating whether a transaction is illegal or not generated after the first model; and transforming the second distribution so as to approximate the first distribution.

(Supplementary note 10) A score distribution transformation program causing a computer to execute: first distribution calculation processing of calculating a first distribution, which is a distribution of scores obtained by applying each data included in a first group of data to a first model; second distribution calculation processing of calculating a second distribution, which is a distribution of scores obtained by applying each data included in a second group of data to a second model; and transformation processing of transforming the second distribution so as to approximate the first distribution, wherein the first group of data and the second group of data are data from the same domain, and a range of scores obtained by applying the data to the first model and a range of scores obtained by applying the data to the second model are identical.

(Supplementary note 11) The score distribution transformation program according to claim 10, wherein, in the transformation processing, a logit transformation is performed on the first distribution and the second distribution, a shape approximation transformation is performed to approximate the shape of the logit transformed second distribution to the shape of the logit transformed first distribution, and a transformation is performed to apply a sigmoid function to the shape approximation transformed distribution for the logit transformed second distribution to approximate the second distribution to the first distribution.

(Supplementary note 12) A score distribution transformation program causing a computer to execute: first distribution calculation processing of calculating a first distribution which is a distribution of scores indicating a likelihood of an illegal transaction obtained by applying each stock transaction data included in a first group of data to a first model which is a model for estimating whether a transaction is illegal or not; second distribution calculation processing of calculating a second distribution which is a distribution of scores indicating a likelihood of an illegal transaction obtained by applying each stock transaction data included in a second group of data to a second model which is a model for estimating whether a transaction is illegal or not generated after the first model; and transformation processing of transforming the second distribution so as to approximate the first distribution.

Although the present invention has been described with reference to the exemplary embodiments and examples, the present invention is not limited to the foregoing exemplary embodiments and examples. Various changes understandable by those skilled in the art can be made to the structures and details of the present invention within the scope of the present invention.

This application claims priority based on Japanese Patent Application No. 2019-51121 filed on Mar. 19, 2019, the disclosure of which is incorporated herein in its entirety.

### REFERENCE SIGNS LIST

10 storage unit

20 first distribution calculation unit

30 second distribution calculation unit

40 transformation unit

50 output unit

What is claimed is:

1. A score distribution transformation device, comprising a hardware processor configured to execute a software code to:
calculate a first distribution, which is a distribution of scores obtained by applying each data included in a first group of data to a first model;
calculate a second distribution, which is a distribution of scores obtained by applying each data included in a second group of data to a second model; and
transform the second distribution so as to approximate the first distribution,
wherein the first group of data and the second group of data are data from the same domain, and a range of scores obtained by applying the data to the first model and a range of scores obtained by applying the data to the second model are identical.

2. The score distribution transformation device according to claim 1, wherein the hardware processor is configured to execute a software code to
perform a logit transformation on the first distribution and the second distribution, perform a shape approximation transformation to approximate the shape of the logit transformed second distribution to the shape of the logit transformed first distribution, and perform a transformation to apply a sigmoid function to the shape approximation transformed distribution for the logit transformed second distribution to approximate the second distribution to the first distribution.

3. The score distribution transformation device according to claim 1,
wherein the second model is generated after the first model, and the second group of data includes at least some of the data included in the first group of data.

4. The score distribution transformation device according to claim 1, wherein the hardware processor is configured to execute a software code to
output the distribution that is the result of transforming the second distribution to approximate the first distribution.

5. The score distribution transformation device according to claim 1,
wherein the data included in the first group of data and the second group of data are stock transaction data, and the first model and the second model are models for estimating whether a transaction indicated by the stock transaction data is unauthorized transaction or not, and the second group of data includes data acquired after data included in the first group of data.

6. A score distribution transformation device, comprising a hardware processor configured to execute a software code to:
calculate a first distribution which is a distribution of scores indicating a likelihood of an illegal transaction obtained by applying each stock transaction data included in a first group of data to a first model which is a model for estimating whether a transaction is illegal or not;
calculate a second distribution which is a distribution of scores indicating a likelihood of an illegal transaction obtained by applying each stock transaction data included in a second group of data to a second model which is a model for estimating whether a transaction is illegal or not generated after the first model; and
transform the second distribution so as to approximate the first distribution.

7. A score distribution transformation method comprising:
calculating a first distribution, which is a distribution of scores obtained by applying each data included in a first group of data to a first model;
calculating a second distribution, which is a distribution of scores obtained by applying each data included in a second group of data to a second model; and
transforming the second distribution so as to approximate the first distribution,
wherein the first group of data and the second group of data are data from the same domain, and a range of scores obtained by applying the data to the first model and a range of scores obtained by applying the data to the second model are identical.

8. A score distribution transformation method according to claim 7, further comprising:
performing a logit transformation on the first distribution and the second distribution;
performing a shape approximation transformation to approximate the shape of the logit transformed second distribution to the shape of the logit transformed first distribution; and
performing a transformation to apply a sigmoid function to the shape approximation transformed distribution for the logit transformed second distribution to approximate the second distribution to the first distribution.

9-12. (canceled)
